(19) United States
(12) Patent Application Publication
(10) Pub. No.: US 2026/0369849 A1
(43) Pub. Date: Nov. 19, 2026

(54) FILLING DEVICE FOR BATTERY CELLS

(71) Applicant: Industrie-Partner GmbH Radebeul-Coswig, Coswig (DE)

(72) Inventors: Ralf Hock, Chemnitz (DE); Christian Weiler, Dresden (DE); Jens Voigt, Dresden (DE); Toni Bläsche, Radebeul (DE)

(21) Appl. No.: 19/144,037

(22) PCT Filed: Nov. 15, 2023
(86) PCT No.: PCT/EP2023/081877

§ 371 Date: Jun. 27, 2025

(30) Foreign Application Priority Data
Dec. 30, 2022 (DE) 10 2022 135 060.6

(51) Int. Cl. H01M 50/609

(52) U.S. Cl. CPC H01M 50/609

(57) ABSTRACT

In order to create a filling device (1) for battery cells (2) by means of which the time needed to fill the battery cells (2) with battery fluid can be minimised, the invention proposes that the filling device (1) has a cell nest (3) in which the battery cell (2) can be received and in which the outer wall (4) of the battery cell (2) can be supported.

### CROSS REFERENCE TO RELATED APPLICATION

The present invention is a national stage application of International Patent Application No. PCT/EP2023/081877, filed Nov. 15, 2023, and claims benefit of German patent application no. 10 2022 135 060.6, filed Dec. 30, 2022.

### BACKGROUND AND FIELD OF THE INVENTION

The invention relates to a filling device for battery cells, e.g. Li-ion battery cells. When producing battery assemblies composed of such battery cells, the time required for filling the battery cells with battery fluid is long, as has been proved to be the case. In this regard, the stack or coil density of the electrodes or separators provided in the battery cells is to be taken into account. The higher the coil density, the longer the time required for filling the battery cells with battery fluid. As a variable influencing this time required, the negative pressure applied in the battery cell prior to filling thereof is also to be taken into account. Negative pressures of 4 to 6 mbar are generally typical. Furthermore, the time required for filling the battery cells with battery fluid can be influenced by the filling or metering pressure at which the battery fluid is filled into the battery cell.

### SUMMARY OF THE INVENTION

The present invention provides a filling device for battery cells, by means of which it can be ensured that the time required for filling the battery cells with battery fluid can be minimized, without the risk of bursting or damaging the outer wall of the battery cells.

In accordance with an embodiment of the invention the filling device comprises a cell nest in which the battery cell can be received and the outer wall of the battery cell can be supported. By supporting the outer wall of the battery cell, the filling process can be performed at a metering or filling pressure which is considerably increased compared with the prior art, and so the time required for the time-critical filling of the battery cells with battery fluid can be considerably reduced.

In order to ensure support of the battery cell on all sides during the filling process, it is expedient if the cell nest is open on one side and can be closed by means of a closure wall, wherein in that case the introduction of the battery cell into the filling device is considerably simplified.

According to an advantageous development of the filling device in accordance with an embodiment of the invention, the cell nest is open on its top side and can be covered by a cover. In order to fill the battery cell with battery fluid with a technical/design outlay which is as low as possible, it is advantageous if the battery cell located in the cell nest can be filled by a filling nozzle or metering needle which extends through the closure wall or through the cover.

In order to simplify the introduction of the battery cell into the filling device in accordance with the invention, in an advantageous embodiment of the filling device in accordance with the invention the closure wall or the cover or the cell nest can be moved away from the cell nest or respectively from the closure wall or from the cover in order to place the battery cell into the cell nest, or, after placing the battery cell into the cell nest, can be moved towards the cell nest or respectively towards the closure wall or towards the cover. In an expedient embodiment of the filling device in accordance with the invention, the inner contour of the cell nest corresponds to the outer contour of the battery cell so that the battery cell can be received in the cell nest or in the filling device in a form-fitting manner, whereby undue stresses on the outer wall of the battery cell can be reliably precluded.

Alternatively, it is possible to configure a receiving space of the cell nest, used to receive the battery cell, so that it can be pressurized and to support the outer wall of the battery cell during the filling process by means of the pressurisation in the receiving space of the cell nest. Depending on the specification for the pressurisation of the receiving space of the cell nest, a correspondingly increased filling or metering pressure can then be achieved.

In order to permit pressurization of the receiving space of the cell nest which is as high as possible, it is advantageous if a seal is arranged between the closure wall or the cover on the one hand and the cell nest on the other hand.

In an expedient manner, the inner contour of the receiving space of the cell nest, used to receive the battery cell, is not adapted to the contour of the outer wall of the battery cell to be filled with battery fluid in the filling device. In this embodiment, as long as it is ensured that an intermediate space remains between the inner contour or inner wall of the receiving space of the cell nest, used to receive the battery cell, on the one hand and the outer wall of the battery cell to be filled with battery fluid in the filling device on the other hand, then a planned filling process of the battery cell can be reliably ensured under almost any adjustable pressure. Therefore, battery cells having different contours can be filled within one and the same filling device.

When using the filling device described above or implementing a filling method for battery cells which can be performed on said device, the outer wall of the battery cells is supported during the filling process. For support purposes, the battery cell, during the filling process, is either received in a cell nest of the filling device in a form-fitting manner or the outer wall of the battery cell is pressurized within the cell nest during the filling process.

The invention will be explained in greater detail hereinafter with the aid of embodiments with reference to the drawings.

### BRIEF DESCRIPTION OF THE DRAWINGS

FIG. 1 shows a schematic sectional illustration of a first embodiment of the filling device for battery cells in accordance with the invention; and

FIG. 2 shows a schematic sectional illustration of a second embodiment of the filling device for battery cells in accordance with the invention.

### DESCRIPTION OF THE PREFERRED EMBODIMENTS

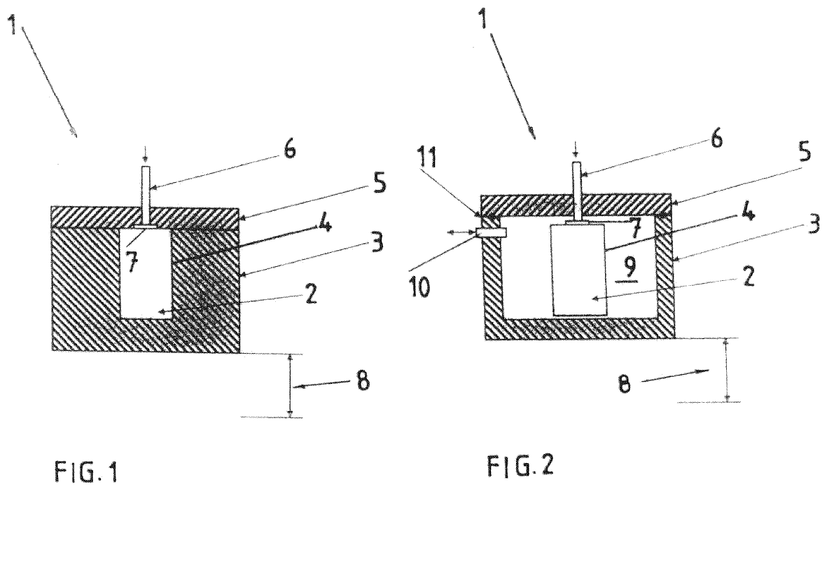

With respect to an embodiment, illustrated in a schematic sectional view in FIG. 1, of a filling device 1 in accordance with the invention, by means of which a battery cell, preferably an Li-ion battery cell 2, is to be filled with battery fluid, has a cell nest 3, the opening surface of which is formed on its top outer surface in the embodiment of the filling device shown in FIG. 1. In the case of the embodiment of the filling device 1 shown in FIG. 1, the inner contour of the cell nest 3 corresponds to the outer contour, an outer wall 4 of the battery cell 2. On the top side of the cell nest 3 comprising the opening surface, this can be closed by means of a closure wall, e.g. by means of the cover 5 shown in FIG. 1, and so the battery cell 2 can be received within the cell nest 3, enclosed on all sides.

Extending through the cover 5 is a metering needle 6, through which battery fluid can be introduced into the battery cell 2 provided for this purpose with a connection element 7. The battery fluid is introduced through the metering needle 6 at a positive pressure in order to keep the time required for the filling process as short as possible. Since the outer wall 4 of the battery cell 2 is supported by the inner contour of the cell nest 3 or the lower surface of the cover 5, when the cell nest 3 is closed by means of the cover 5, the filling process can be performed with a high metering pressure since damage to the outer wall 4 of the battery cell 2 is reliably avoided owing to the support of this outer wall 4 in the cell nest 3. In the case of rigid-walled battery cells, a filling nozzle can be provided instead of the metering needle 6.

In order to introduce the battery cell 2 into the cell nest 3 of the filling device 1, the cell nest 3 can be moved away from the cover 5 and moved towards the cover 5, as illustrated schematically in FIG. 1. A corresponding advancing device 8 is shown only schematically in FIG. 1. Alternatively, it is also possible for the cover 5 to be configured to be able to move towards and away from the cell nest 3, instead of vice-versa.

Owing to the form-fitting support of the outer wall 4 of the battery cell 2 during the filling process, the battery cell 2 can be filled with the battery fluid at a considerably higher metering pressure compared with the prior art, and so a comparatively short time consumption is associated with the filling process.

The further embodiment of the filling device 1 in accordance with the invention illustrated in a schematic sectional view in FIG. 2 differs from the embodiment of the filling device 1 shown in FIG. 1 in that the inner contour of a receiving space 9 of the cell nest 3, used to receive the battery cell 2, is not adapted to the contour of the outer wall 4 of the battery cell 2 to be filled with battery fluid in the filling device 1. In the case of the embodiment of the filling device 1 shown in FIG. 2, the receiving space 9 of the cell nest 3 is connected to a source of pressurized fluid, not shown in FIG. 2, by a fluid connection 10 penetrating the wall of the cell nest 3. Accordingly, a positive pressure can be produced in the receiving space 9 of the cell nest 3, by means of which the outer wall 4 of the battery cell 2 to be filled with battery fluid and located in the receiving space 9 can be supported. The higher the pressurisation of the receiving space 9, the higher the metering pressure can be, by means of which the battery cell 2 is filled with battery fluid. Accordingly, in the case of the filling device 1 described above, the time required for filling the battery cell 2 with battery fluid can be considerably reduced.

Battery cells 2 having different contours can be filled in one and the same receiving space 9, as long as it is ensured that during the filling process an intermediate space always remains between the inner contour of the receiving space 9 and the outer surface of the battery cell 2 to be filled.

In the case of the embodiment of the filling device 1 shown in FIG. 2, a seal 11 is provided between the lower surface of the cover 5 facing the cell nest 3 and the top edge of the cell nest 3, which seal permits high pressures within the receiving space 9.

A filling device for battery cells by means of which the time needed to fill the battery cells with battery fluid can be minimized, where the filling device has a cell nest in which the battery cell can be received and in which the outer wall of the battery cell can be supported.

1. A filling device for battery cells, wherein the filling device comprises a cell nest in which the battery cell is received and an outer wall of the battery cell is supported.

2. The filling device as claimed in claim 1, wherein the cell nest is open on one side and is closeable by a closure wall.

3. The filling device as claimed in claim 2, wherein the cell nest is open on its top side and is coverable by a cover.

4. The filling device as claimed in claim 3, wherein the battery cell located in the cell nest is fillable via a filling nozzle or a metering needle that extends through the closure wall or the cover.

5. The filling device as claimed in claim 4, wherein the closure wall or the cover or the cell nest is moveable away from the cell nest or respectively from the closure wall or from the cover to place the battery cell into the cell nest, or, after placing the battery cell into the cell nest, is moveable towards the cell nest or respectively towards the closure wall or towards the cover.

6. The filling device as claimed in claim 3, wherein an inner contour of the cell nest corresponds to an outer contour of the battery cell such that the battery cell is receivable in the cell nest or in the filling device in a form-fitting manner.

7. The filling device as claimed in claim 3, wherein a receiving space of the cell nest used to receive the battery cell is configured to be pressurized via which the outer wall of the battery cell is supported during the filling process.

8. The filling device as claimed in claim 7, further comprising a seal that is arranged between the closure wall or the cover and the cell nest.

9. The filling device as claimed in claim 8, wherein the inner contour of the receiving space of the cell nest used to receive the battery cell is not adapted to the contour of the outer wall of the battery cell to be filled with battery fluid in the filling device.

10. A method of filling battery cells, comprising supporting an outer wall of the battery cells during a filling process.

11. The filling method as claimed in claim 10, further comprising receiving the battery cells in a cell nest in a form-fitting manner during the filling process.

12. The filling method as claimed in claim 10, further comprising pressurizing the outer wall of the battery cells in a cell nest during the filling process.

13. The filling device as claimed in claim 2, wherein the battery cell located in the cell nest is fillable via a filling nozzle or a metering needle that extends through the closure wall or the cover.

14. The filling device as claimed in claim 2, wherein the closure wall or the cover or the cell nest is moveable away from the cell nest or respectively from the closure wall or from the cover to place the battery cell into the cell nest, or, after placing the battery cell into the cell nest, is moveable towards the cell nest or respectively towards the closure wall or towards the cover.

15. The filling device as claimed in claim 3, wherein the closure wall or the cover or the cell nest is moveable away from the cell nest or respectively from the closure wall or from the cover to place the battery cell into the cell nest, or, after placing the battery cell into the cell nest, is moveable towards the cell nest or respectively towards the closure wall or towards the cover.

16. The filling device as claimed in claim 1, wherein an inner contour of the cell nest corresponds to an outer contour of the battery cell such that the battery cell is receivable in the cell nest or in the filling device in a form-fitting manner.

17. The filling device as claimed in claim 2, wherein an inner contour of the cell nest corresponds to an outer contour of the battery cell such that the battery cell is receivable in the cell nest or in the filling device in a form-fitting manner.

18. The filling device as claimed in claim 1, wherein a receiving space of the cell nest used to receive the battery cell is configured to be pressurized via which the outer wall of the battery cell is supported during the filling process.

19. The filling device as claimed in claim 18, further comprising a seal that is arranged between the closure wall or the cover and the cell nest.

20. The filling device as claimed in claim 18, wherein the inner contour of the receiving space of the cell nest used to receive the battery cell is not adapted to the contour of the outer wall of the battery cell to be filled with battery fluid in the filling device.
